(19) United States
(12) Patent Application Publication
(10) Pub. No.: US 2024/0400201 A1
(43) Pub. Date: Dec. 5, 2024

(54) IMAGE GENERATION APPARATUS, IMAGE GENERATION METHOD, AND COMPUTER-READABLE STORAGE MEDIUM

(71) Applicant: JVCKENWOOD Corporation, Yokohama-shi (JP)

(72) Inventor: Takayuki Sugahara, Yokohama-shi (JP)

(21) Appl. No.: 18/804,164

(22) Filed: Aug. 14, 2024

Related U.S. Application Data
(63) Continuation of application No. PCT/JP2022/042318, filed on Nov. 15, 2022.

(30) Foreign Application Priority Data
Mar. 28, 2022 (JP) 2022-051887

(51) Int. Cl. B64C 39/02; G06F 3/01; G06T 15/00; G06V 20/17

(52) U.S. Cl. CPC B64C 39/024; G06F 3/013; G06T 15/00; G06V 20/17

(57) ABSTRACT

An image generation apparatus includes: a data acquisition unit that acquires image data of a target from imaging devices mounted on a mobile body; a first image generation unit that generates a three-dimensional image of the target based on the image data; a second image generation unit that generates a two-dimensional image of the target as viewed from a specific viewpoint using the three-dimensional image; a user information acquisition unit that acquires position and line-of-sight information of a user who operates the mobile body; and a mobile body control unit that controls a moving position of the mobile body based on position information of the mobile body, and the user's position and line-of-sight information. The mobile body control unit controls a moving position of the mobile body such that the user is positioned in a region defined by connection lines connecting a vertex of the target to the imaging devices.

### CROSS-REFERENCE TO RELATED APPLICATION

This application is a Continuation of PCT International Application No. PCT/JP2022/042318 filed on Nov. 15, 2022 which claims the benefit of priority from Japanese Patent Application No. 2022-051887 filed on Mar. 28, 2022, the entire contents of both of which are incorporated herein by reference.

### BACKGROUND OF THE INVENTION

The present disclosure relates to an image generation apparatus, an image generation method, and a computer-readable storage medium.

Unmanned aerial vehicles such as drones have been used in various industries. A camera is mounted on a drone, and an image captured by the camera is effectively used. For example, JP 2018-522302 A discloses an example of techniques of controlling the flight of the drone.

A drone is equipped with a camera. A user can control the flight of the drone and use the camera to capture images of places that are not easily visited by the user. It is desired to further effectively use images captured by a camera mounted on a drone.

### SUMMARY

An image generation apparatus according to the present disclosure includes: a data acquisition unit configured to acquire image data of a target from a plurality of imaging devices mounted on a mobile body; a first image generation unit configured to generate a three-dimensional image of the target based on the image data; a second image generation unit configured to generate a two-dimensional image of the target as viewed from a designated specific viewpoint using the three-dimensional image; a user information acquisition unit configured to acquire position information and line-of-sight information of a user who operates the mobile bodies; and a mobile body control unit configured to control a moving position of the mobile body based on position information of the mobile body, and the position information and the line-of-sight information of the user. The mobile body control unit controls a moving position of the mobile body such that the user is positioned in a region defined by a plurality of connection lines connecting a vertex of the target to the imaging devices.

An image generation method according to the present disclosure includes: acquiring image data of a target from a plurality of imaging devices mounted on a mobile body; generating a three-dimensional image of the target based on the image data; generating a two-dimensional image of the target as viewed from a designated specific viewpoint using the three-dimensional image; acquiring position information and line-of-sight information of a user who operates the mobile body; and controlling a position of the mobile body based on position information of the mobile body, and the position information and the line-of-sight information of the user. The controlling includes controlling a moving position of the mobile body such that the user is positioned in a region defined by a plurality of connection lines connecting a vertex of the target to the imaging devices.

A non-transitory computer-readable storage medium according the present disclosure stores a program causing a computer to perform: acquiring image data of a target from a plurality of imaging devices mounted on a mobile body; generating a three-dimensional image of the target based on the image data; generating a two-dimensional image of the target as viewed from a designated specific viewpoint using the three-dimensional image; acquiring position information and line-of-sight information of a user who operates the mobile body; and controlling a position of the mobile body based on position information of the mobile body, and the position information and the line-of-sight information of the user. The controlling includes controlling a moving position of the mobile body such that the user is positioned in a region defined by a plurality of connection lines connecting a vertex of the target to the imaging devices.

### BRIEF DESCRIPTION OF THE DRAWINGS

FIG. 1 is a conceptual diagram illustrating an imaging system according to a first embodiment;

FIG. 2 is a plan view illustrating a drone;

FIG. 3 is a block diagram illustrating an imaging system;

FIG. 4 is a block diagram illustrating an image generation apparatus;

FIG. 5 is a flowchart illustrating an image generation method;

FIG. 6 is a block diagram illustrating a specific configuration of a first image generation unit;

FIG. 7 is an explanatory diagram illustrating a positional relationship between two images to which the photogrammetry principle is to be applied;

FIG. 8 is an explanatory diagram illustrating a positional relationship between two images;

FIG. 9 is a conceptual diagram illustrating an image generation apparatus according to a second embodiment;

FIG. 10 is a block diagram illustrating an imaging system according to the second embodiment;

FIG. 11 is a plan view illustrating a positional relationship among a target, a user, and a camera; and

FIG. 12 is a side view illustrating a positional relationship among the target, the user, and the camera.

### DETAILED DESCRIPTION

Hereinafter, embodiments of an image generation apparatus, an image generation method, and a program according to the present invention will be described in detail with reference to the accompanying drawings. Note that the present invention is not limited by the embodiments below.

### Concept of Imaging System

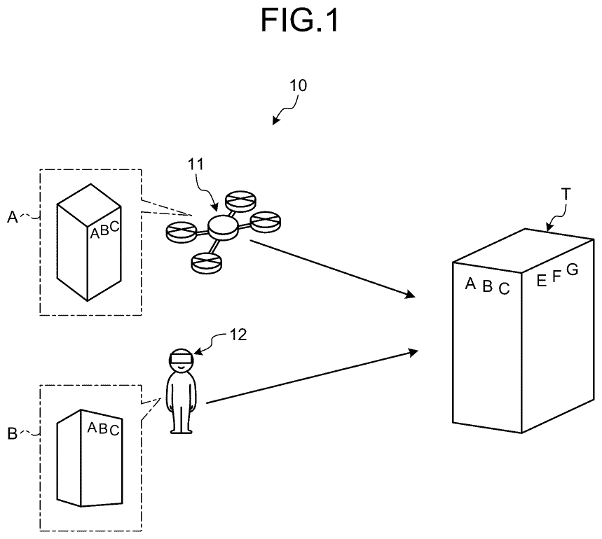

FIG. 1 is a conceptual diagram illustrating an imaging system according to a first embodiment.

As illustrated in FIG. 1, a target T captured by an imaging system 10 is, for example, a building. However, the target T is not limited to a building, and may be various objects such as a person, an animal, and a vehicle. The imaging system 10 performs communication between a drone (mobile body) 11, which is an unmanned aerial vehicle, and a display apparatus 12 possessed by a user. Although the mobile body is represented by the drone 11, it is not limited to this configuration, and may be a helicopter, a vehicle, a spacecraft, or the like.

The user can control the flight of the drone 11. The drone 11 is equipped with a plurality of cameras and captures images of the user and the target T in the user's line of sight. The drone 11 is also equipped with an image generation apparatus. The image generation apparatus generates three-dimensional image (three-dimensional model) data based on a plurality of pieces of image data acquired by capturing images using the cameras. An image A is a two-dimensional image of the target T viewed from the drone 11, and the three-dimensional image is an image generated from the image (two-dimensional image) A of the target T viewed from the drone 11. The image generation apparatus performs viewpoint transformation on the generated three-dimensional image to generate an image B of the target T as viewed from the user.

The drone 11 transmits the image B of the target T as viewed from the user, which has been generated by the image generation apparatus, to the display apparatus 12 of the user. The display apparatus 12 displays the image B of the target T. Therefore, the user can view and save the image B of the target T even though the user carries no camera.

### Drone

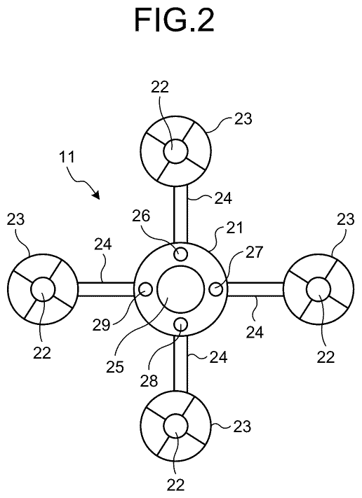

FIG. 2 is a plan view illustrating a drone.

As illustrated in FIG. 2, the drone 11 includes a main body 21, a plurality of (four in the present embodiment) drive units 22, and a plurality of (four in the present embodiment) propellers 23. The main body 21 is configured such that a plurality of (four in the present embodiment) coupling portions 24 extends outward from the outer periphery of the main body 21, with the drive unit 22 and the propeller 23 attached to the distal end of each coupling portion 24. With the propellers 23 rotated by their respective drive units 22, the drone 11 is capable of flying.

The drone 11 is equipped with a first camera 25 and second cameras 26, 27, 28, and 29. The first camera 25 has an imaging visual field in all directions (360 degrees) around the drone 11. Each of the second cameras 26, 27, 28, and 29 has an imaging visual field of at least ¼ (90 degrees) in all directions around the drone 11. In this case, the second cameras 26, 27, 28, and 29 are preferably configured such that imaging visual fields of adjacent cameras partially overlap each other.

### Configuration of Imaging System

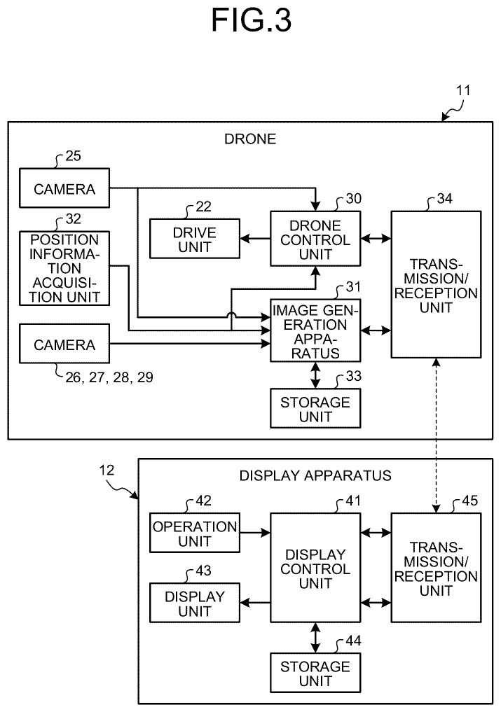

FIG. 3 is a block diagram illustrating an imaging system.

As illustrated in FIG. 3, the drone 11 includes the drive units 22, the first camera (a user information acquisition unit) 25, the second cameras (imaging devices) 26, 27, 28, and 29, a drone control unit (mobile body control unit) 30, an image generation apparatus 31, a position information acquisition unit (mobile body position information acquisition unit) 32, a storage unit 33, and a transmission/reception unit 34.

The first camera 25 is capable of capturing an image at least the user. The first camera 25 photographs (images) the user to acquire, as user information, the user's position and the user's line of sight. The user information acquisition unit is not limited to the first camera 25. User information acquired by the display apparatus 12 possessed by the user or another apparatus may be transmitted to the drone 11. For example, the user's position may be acquired using a global navigation satellite system (GNSS), a global positioning system (GPS), or the like. The user's line of sight may be acquired by detecting the face direction of the user or the pointing direction of the finger using a gyro sensor. Further, a light-of-sight detector may be used to acquire the line of sight of the user.

The second cameras 26, 27, 28, and 29 are each capable of photographing (imaging) the target T. The second cameras 26, 27, 28, and 29 each capture an image of the target T located in the user's line of sight. The second cameras 26, 27, 28, and 29 photograph the target T at predetermined time intervals or each time the drone 11 moves a predetermined distance.

The drone control unit 30 controls driving of the drive units 22 to set the position, direction, speed, and the like of the drone 11 to control the flight of the drone 11. The position of the drone 11 is preferably set according to the position of the user. For example, the flight position of the drone 11 is a position at a predetermined distance away from the user where at least two of the second cameras 26, 27, 28, and 29 can capture an image of the target T located in the user's line of sight. A flight control program for the drone 11 used by the drone control unit 30 is preconfigured and stored in a storage unit (not illustrated).

As will be described below, the image generation apparatus 31 generates a three-dimensional image based on a plurality of pieces of image data captured by at least two of the second cameras 26, 27, 28, and 29, and uses the generated three-dimensional image to generate an image of the target T as viewed by the user.

The position information acquisition unit 32 acquires flight position information of the drone 11. The position information acquisition unit 32 acquires flight position information of the drone 11 using a global navigation satellite system (GNSS), a global positioning system (GPS), or the like.

The storage unit 33 stores image data captured by the second cameras 26, 27, 28, and 29, image data of the three-dimensional image of the target T generated by the image generation apparatus 31, and image data of the target T as viewed by the user.

The transmission/reception unit 34 transmits and receives various types of data to and from the display apparatus 12 possessed by the user.

The drone control unit 30 and the image generation apparatus 31 may be constituted with an arithmetic circuit such as a central processing unit (CPU), for example. The storage unit 33 is an external storage device such as a hard disk drive (HDD), a memory device, or the like.

The display apparatus 12 includes a display control unit 41, an operation unit 42, a display unit 43, a storage unit 44, and a transmission/reception unit 45. The display apparatus 12 is, for example, a head mount type display apparatus (head mounted display). However, the display apparatus 12 is not limited to this configuration, and the operation unit 42, the display unit 43, the storage unit 44, and the transmission/reception unit 45 may be configured separately.

The display control unit 41 controls the display of the image data of the target T transmitted from the drone 11 and received by the display apparatus 12. That is, the display control unit 41 displays, on the display unit 43, the image of the target T as viewed by the user, which has been generated by the image generation apparatus 31 of the drone 11.

The operation unit 42 is configured to be operated by a user. The operation unit 42 is capable of inputting command signals to the display control unit 41. The operation unit 42 can start and end the display of the image data of the target T on the display unit 43, for example. The operation unit 42 can switch the image of the target T as viewed by the user displayed on the display unit 43, for example.

Display of the display unit 43 is controllable by the display control unit 41. The display unit 43 displays the image of the target T as viewed by the user, which is input from the display control unit 41.

The storage unit 44 stores the image of the target T as viewed by the user, which is input from the display control unit 41.

The transmission/reception unit 45 can transmit and receive various types of data to and from the transmission/reception unit 34 provided on the drone.

The display control unit 41 is constituted with an arithmetic circuit such as a central processing unit (CPU), for example. The storage unit 44 is an external storage device such as a hard disk drive (HDD), a memory device, or the like.

### Image Generation Apparatus

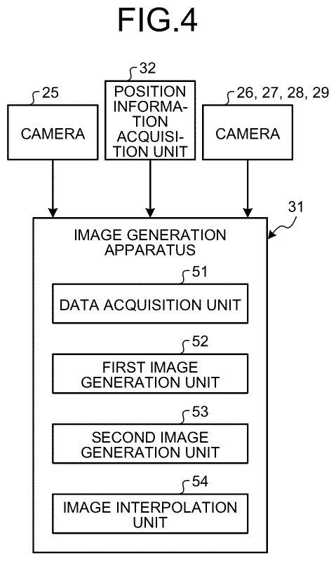

FIG. 4 is a block diagram illustrating an image generation apparatus.

As illustrated in FIG. 4, the image generation apparatus 31 includes a data acquisition unit 51, a first image generation unit 52, a second image generation unit 53, and an image interpolation unit 54.

Based on the image data captured by the first camera 25, the data acquisition unit 51 acquires the user's position and the user's line of sight as user information. The second cameras 26, 27, 28, and 29 capture an image of the target T located in the user's line of sight. In this case, the drone control unit 30 specifies a region in front of the user's line of sight, i.e., the target T, based on the user's line of sight. The drone control unit 30 controls the driving of the drive unit 22 so that at least two of the second cameras 26, 27, 28, and 29 are located at positions where they are capable of capturing the image the target T, thereby adjusting the flight position of the drone 11. Therefore, the data acquisition unit 51 acquires image data of the target T captured by at least two of the second cameras 26, 27, 28, and 29.

The first image generation unit 52 generates a three-dimensional image (three-dimensional model) based on two pieces of image data (stereo images) having disparity, obtained by photographing the target T and received by the data acquisition unit 51. Here, the three-dimensional image is a stereoscopic (three-dimensional) digital data having information on length, width, and height, arranged according to a specific rule. Disparity refers to the difference in the direction in which a target point is viewed, or the angular difference, caused by the difference in the positions of two observation points or the difference in the position of a camera placed at one point. The three-dimensional image generated by the first image generation unit 52 is an image of the target T viewed from the position of the drone 11.

The second image generation unit 53 performs perspective transformation on the three-dimensional image generated by the first image generation unit 52 to generate a two-dimensional image of the target T as viewed from the user's position. The perspective transformation is transformation from a three-dimensional normal coordinate system to a two-dimensional perspective coordinate system. In this case, it is necessary to set the viewpoint of the two-dimensional image. That is, the second image generation unit 53 performs perspective transformation on the three-dimensional image of the target T viewed from the position of the drone 11 to and generates a two-dimensional image of the target T as viewed from the user's position by setting the viewpoint to the user's position.

Based on the flight position information of the drone 11 acquired from the position information acquisition unit 32 and the position of the user acquired from the image data captured by the first camera 25, the second image generation unit 53 performs perspective transformation on the three-dimensional image of the target T viewed from the position of the drone 11 to generate a two-dimensional image of the target T as viewed from the user's position. The above-described perspective transformation only requires that the relative positions between the drone 11 and the user be obtained. There may be the user position, the drone position, and the target object position, or these absolute positions may be grasped.

The first image generation unit 52 and the second image generation unit 53 may be the same in terms of hardware, and do not need to exist as separate hardware. Furthermore, as described above, the image generation apparatus 31 is constituted with an arithmetic circuit such as a CPU. The first image generation unit 52 and the second image generation unit 53 may also be constituted by an arithmetic circuit such as a CPU.

The image interpolation unit 54 performs image data interpolation on the two-dimensional image of the target T as viewed from the user's position generated by the second image generation unit 53. The image interpolation unit 54 estimates and interpolates an image of a region that the data acquisition unit 51 was unable to acquire when the second image generation unit 53 generated a two-dimensional image of the target T. Here, the term “interpolation” refers to filling in occlusion portions. The occlusion relates to a region where depth information is lacked, occurring when an object in front hides (a part of) another object in rear, and is related to the front-rear direction as well as the up-down and left-right directions.

In other words, since the position of the drone 11 is different from the position of the user, the region of the target T visible from the drone 11 is different from the region of the target T visible from the user. As a result, the two-dimensional image of the target T as viewed from the user's position generated by the second image generation unit 53 lacks an image of the region of the target T that can be seen only by the user, leading to occurrence of occlusion. Therefore, the image interpolation unit 54 adds a missing image of the target T to eliminate the occlusion.

The image interpolation unit 54 adds an image to the missing region by, for example, extending lines or colors of an image (texture) adjacent to the missing region. Alternatively or additionally, the image interpolation unit 54 may change the flight position of the drone 11, for example, by controlling the drive unit 22 using the drone control unit 30, and cause any of the second cameras 26, 27, 28, and 29 to capture an image of the missing region, thereby adding an image of the missing region from the captured image. Furthermore, the image interpolation unit 54 may recognize, for example, the overall shape and color of the target T, and predicts the image of the missing region, thereby adding the image of the missing region. The image interpolation unit 54 may add the image of the missing by, for example, machine learning.

### Image Generation Method

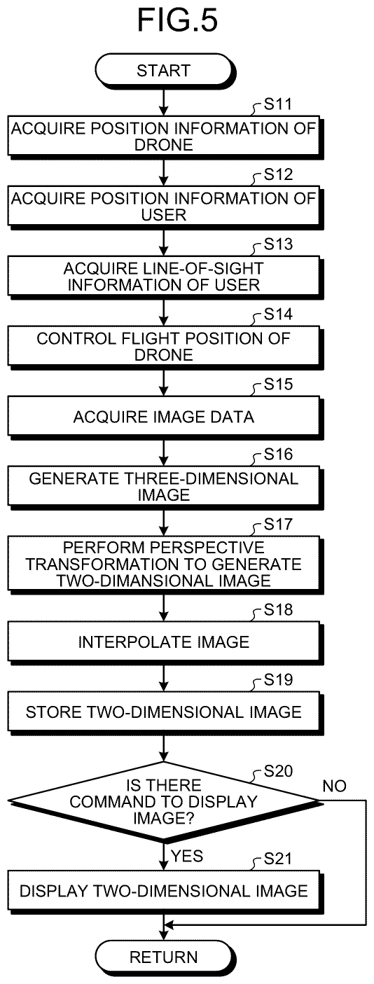

FIG. 5 is a flowchart illustrating an image generation method.

As illustrated in FIGS. 3, 4, and 5, in Step S11, the data acquisition unit 51 acquires the position information of the drone 11 acquired by the position information acquisition unit 32. In Step S12, the data acquisition unit 51 acquires the position information of the user from the image of the user captured by the first camera 25. In Step S13, the data acquisition unit 51 acquires the line-of-sight information of the user from the image of the user captured by the first camera 25. Here, the image generation apparatus 31 specifies the target T in the user's line of sight based on the user's line-of-sight information. In Step S14, the drone control unit 30 controls the driving of each of the drive units 22 to adjust the flight position of the drone 11 to an optimum position. That is, the drone control unit 30 adjusts the flight position so that the drone 11 is a position at a predetermined distance away from the user where at least two of the second cameras 26, 27, 28, and 29 can capture an image of the target T.

In Step S15, the data acquisition unit 51 acquires two pieces of image data of the target T located in the line of sight of the user among the four pieces of image data acquired by the second cameras 26, 27, 28, and 29. The two pieces of image data of the target T acquired by the data acquisition unit 51 are preferably images having disparities in the horizontal and the vertical directions.

In Step S16, the first image generation unit 52 generates a three-dimensional image (three-dimensional model) based on the two pieces of image data of the target T acquired by the data acquisition unit 51. The three-dimensional image generated by the first image generation unit 52 is a three-dimensional image of the target T viewed from the position of the drone 11. In Step S17, the second image generation unit 53 performs perspective transformation (viewpoint transformation) on the three-dimensional image generated by the first image generation unit 52 to generate a two-dimensional image of the target T as viewed from the user's position.

In Step S18, the image interpolation unit 54 estimates and interpolates an image of a region that the data acquisition unit 51 was unable to acquire from the two-dimensional image of the target T as viewed from the user's position generated by the second image generation unit 53. The image interpolation unit 54 changes the flight position of the drone 11 by, for example, controlling the driving of the drive unit 22 via the drone control unit 30. Subsequently, any of the second cameras 26, 27, 28, and 29 captures an image of the missing region of the target T, and the image interpolation unit 54 adds an image of the missing region from the captured image to generate a two-dimensional image without occlusion. When there is no region that the data acquisition unit 51 was unable to acquire in the two-dimensional image of the target T as viewed from the user's position generated by the second image generation unit 53, the image interpolation unit 54 does not perform interpolation processing.

In Step S19, the second image generation unit 53 or the image interpolation unit 54 stores, in the storage unit 33, the generated two-dimensional image of the target T as viewed from the user's position. In Step S20, the image generation apparatus 31 determines whether a command to display the generated two-dimensional image has been input by the user. When the user has a desire to view an image of the target T in front of the user's line of sight, the user outputs a display command to the display control unit 41. The user can output the display command to the display control unit 41 by operating the operation unit 42. When the display command is input by the user, the display control unit 41 outputs the display command to the image generation apparatus 31 via the transmission/reception units 45 and 34.

When the image generation apparatus 31 determines that the command to display the generated two-dimensional image has not been input from the user (No), the image generation apparatus 31 exits this routine. In contrast, when the image generation apparatus 31 determines that the command to display the generated two-dimensional image has been input from the user (Yes), the image generation apparatus 31 outputs the generated image of the target T to the display control unit 41 via the transmission/reception units 34 and 45. In Step S21, when the image of the target T is input, the display control unit 41 displays the image of the target T on the display unit 43. The display control unit 41 records the image of the target T in the storage unit 44 as necessary.

The processing from Step S11 to Step S21 is performed at predetermined time intervals or each time the drone 11 moves a predetermined distance. The two-dimensional image displayed on the display unit 43 is switched each time the user outputs a display command.

Although the image generation apparatus 31 is described as determining whether a command to display a two-dimensional image has been input by the user, the image generation apparatus 31 may make a judgment on whether the generated two-dimensional image is displayed. Although the user operates the operation unit 42 to output the display command, the configuration is not limited to this. For example, the user points in the direction of the target T with his/her finger. Subsequently, the first camera 25 captures an image of the user pointing with his/her finger in the direction of the target T, and the image generation apparatus 31 receives the image of the user pointing with his/her finger in the direction of the target T as a display command. Subsequently, the image generation apparatus 31 outputs the generated image of the target T to the display control unit 41 via the transmission/reception units 34 and 45. In this case, it is set in advance that an image of a user pointing with his/her finger in the direction of the target T is a display command. The operation of the display command may be other actions of the user.

### Specific Example of Generation Direction of Three-Dimensional Image

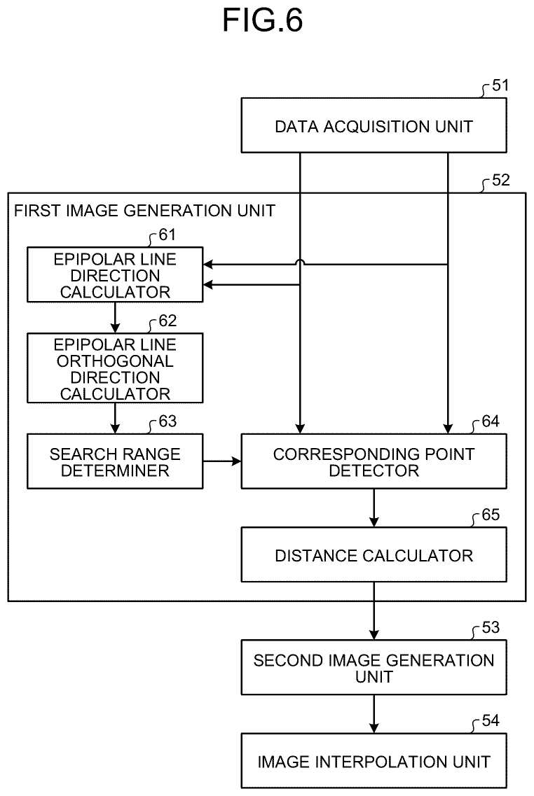

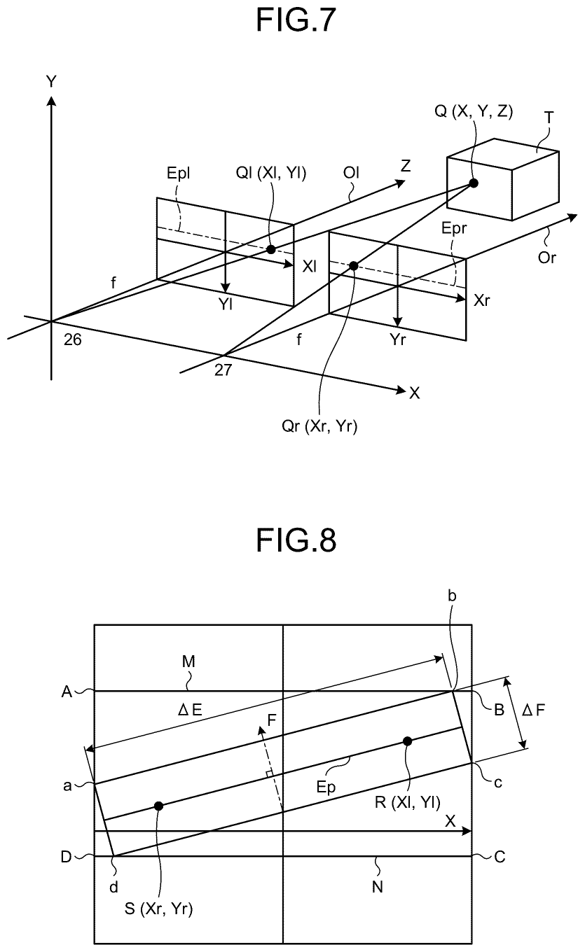

FIG. 6 is a block diagram illustrating a specific configuration of the first image generation unit; FIG. 7 is an explanatory diagram illustrating a positional relationship between two images to which the photogrammetry principle is to be applied; and FIG. 8 is an explanatory diagram illustrating a positional relationship between two images.

As illustrated in FIG. 6, the first image generation unit 52 includes an epipolar line direction calculator 61, an epipolar line orthogonal direction calculator 62, a search range determiner 63, a corresponding point detector 64, and a distance calculator 65.

The epipolar line direction calculator 61 calculates, based on a plurality of pieces of image data (two in the present embodiment) acquired by the data acquisition unit 51, a direction of an epipolar line connecting corresponding pixel points of the pieces of image data of the target T. The epipolar line direction calculator 61 sends the calculated epipolar line direction to the epipolar line orthogonal direction calculator 62.

The epipolar line orthogonal direction calculator 62 calculates an orthogonal direction that is orthogonal to the epipolar line. The epipolar line orthogonal direction calculator 62 outputs the calculated orthogonal direction with respect to the epipolar line to the search range determiner 63.

The search range determiner 63 determines a two-dimensional search range on a screen so as to include a plurality of pixel points corresponding to the direction of the epipolar line and to the orthogonal direction with respect to the epipolar line. The search range determiner 63 outputs the determined two-dimensional search range to the corresponding point detector 64.

The corresponding point detector 64 performs a corresponding point search based on the plurality of pieces of image data acquired by the data acquisition unit 51 and the determined two-dimensional search range, thereby obtaining a disparity vector. The corresponding point detector 64 sends the obtained disparity vector to the distance calculator 65.

The distance calculator 65 maps the disparity vector onto an epipolar line to obtain an epipolar line direction component of the disparity vector, and calculates the distance to the target T based on the obtained epipolar line direction component. The distance calculator 65 sends the calculated distance to the target T to the second image generation unit 53.

Hereinafter, a method of generating a three-dimensional image (three-dimensional model) by the first image generation unit 52 will be specifically described. Here, a case will be described in which a three-dimensional image is generated from two pieces of image data.

The data acquisition unit 51 acquires two pieces of image data of the target T captured by the second cameras 26, 27, 28, and 29, as a set. The set of image data is triangulated to obtain a three-dimensional point cloud, and collecting these point clouds expands the relative positions and the image of the point clouds. The texture of the portion corresponding to such image data is managed in memory in association with the image data so as to be used for mapping later.

First, two sets of image data are obtained for the target T by the second camera 26 and the second camera 27. Next, the corresponding point detector 64 searches for corresponding points of feature points based on the two sets of image data. The corresponding point detector 64 performs, for example, pixel-by-pixel correspondence and searches for a position where the difference is minimum. Here, as illustrated in FIGS. 6 and 7, it is assumed that the second cameras 26 and 27, which are assumed to exist simultaneously at two viewpoints, are assumed to be arranged in a relationship of Yl=Yr so that optical axes Ol and Or are included on the same X-Z coordinate plane. Using the corresponding points found by the corresponding point detector 64, a disparity vector corresponding to the difference in angle for each pixel is calculated.

Since the obtained disparity vector corresponds to the distance from the second cameras 26 and 27 in the depth direction, the distance calculator 65 calculates the distance in proportion to the magnitude of the disparity according to the perspective law. Assuming that the second cameras 26 and 27 move only substantially horizontally, by disposing the second cameras 26 and 27 such that their optical axes Ol and Or are included on the same X-Z coordinate plane, the search for the corresponding points can be performed only on the scanning lines, which are epipolar lines Epl and Epr. The distance calculator 65 generates a three-dimensional image of the target T using the two pieces of image data of the target T and the respective distances from the second cameras 26 and 27 to the target T.

When a point Ql(Xl, Yl) on the left image corresponds to a point Qr(Xr, Yr) on the right image, the disparity vector at the point Ql(Xl, Yl) is Vp(Xl−Xr, Yl−Yr). Here, the two points Ql and Qr are on the same scanning line (epipolar line), and thus, Yl=Yr holds. Accordingly, the disparity vector is expressed as Vp(Xl−Xr, 0). The epipolar line direction calculator 61 calculates such a disparity vector Vp for all pixel points on the image and creates a group of disparity vectors to obtain information on the depth direction of the image. Regarding a set in which the epipolar line is not horizontal, it is possible (though this is a low probability) that one of two cameras is positioned at a different height. In this case, the epipolar line orthogonal direction calculator 62 searches within a rectangle in the epipolar line direction and in a direction orthogonal to the epipolar line that is approximately a deviation from the horizontal, compared with a case in which a large search range is searched for corresponding points in a large two-dimensional region without consideration of corresponding point matching, thereby reducing the amount of calculation for the minimum rectangle, making it more rational. Subsequently, as illustrated in FIG. 8, the search range determiner 63 determines a search range in a case where the epipolar line direction search range for the minimum rectangle is a to b=c to d and the orthogonal direction search range is b to c=d to a. In this case, a search width in the epipolar line direction is ΔE, and a search width in the direction F orthogonal to the epipolar line is ΔF. The smallest non-inclined rectangle ABCD including the smallest inclined rectangle abcd is a region to be obtained.

As illustrated in FIG. 6, the first image generation unit 52 calculates a disparity vector from the corresponding points of the feature points of the plurality of second cameras 26 and 27 under the epipolar constraint conditions, obtains information on the depth direction for each point, and maps the texture on the surface of the three-dimensional shape to generate a three-dimensional image. With this operation, the model of the portion in the image data used for calculation can reproduce a spatial image viewed from the front hemisphere, i.e., a three-dimensional image viewed from the drone 11. The first image generation unit 52 sends the generated three-dimensional image to the second image generation unit 53.

The second image generation unit 53 uses perspective transformation and converts a three-dimensional image viewed from the drone 11 into a two-dimensional image as viewed from the user by using the method similar to that of the first image generation unit 52, thereby reconstructing the two-dimensional image. The second image generation unit 53 sends the generated two-dimensional image to the image interpolation unit 54. In a case where there is a portion not captured in the image data of the three-dimensional image, the image interpolation unit 54 extends a line or a surface of a surrounding texture, for example, and interpolates between them using the same texture.

### Second Embodiment

### Concept of Imaging System

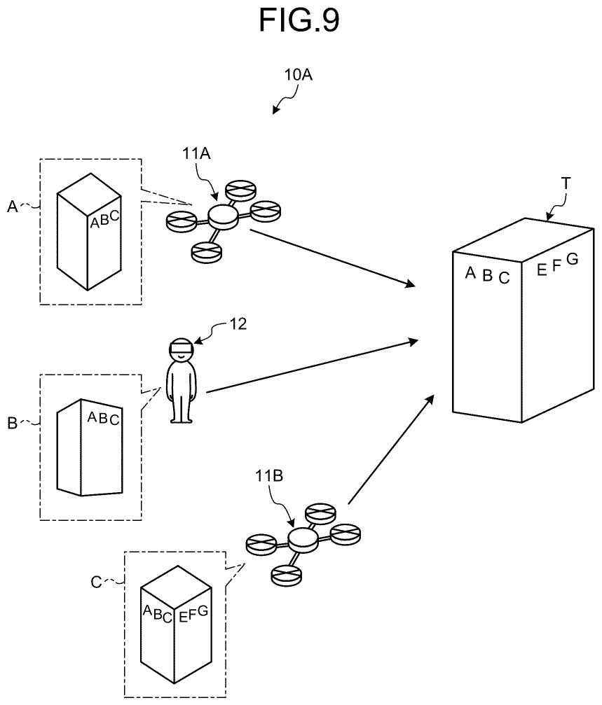

FIG. 9 is a conceptual diagram illustrating an image generation apparatus according to a second embodiment.

As illustrated in FIG. 9, an imaging system 10A performs communication between a plurality of (two in the present embodiment) drones (mobile bodies) 11A and 11B as unmanned aerial vehicles and a display apparatus 12 possessed by a user.

The user can control the flight of the drones 11A and 11B. The drones (mobile bodies) 11A and 11B are each equipped with one (or a plurality of) camera(s), and capture images of the user and the target T in the user's line of sight. The drone 11A is equipped with an image generation apparatus. The image generation apparatus generates three-dimensional image (three-dimensional model) data based on a plurality of pieces of image data acquired by capturing images using a plurality of cameras. Images A and C are two-dimensional images of the target T viewed from the drones 11A and 11B, respectively, and a three-dimensional image is an image generated from the images (two-dimensional images) A and C of the target T viewed from the drones 11A and 11B. The image generation apparatus performs viewpoint transformation on the generated three-dimensional image to generate an image B of the target T as viewed from the user.

The drones 11A and 11B transmit the image B of the target T as viewed from the user generated by the image generation apparatus to the display apparatus 12 of the user. The display apparatus 12 displays the image B of the target T. Therefore, the user can view and save the image B of the target T even though the user carries no camera.

### Configuration of Imaging System

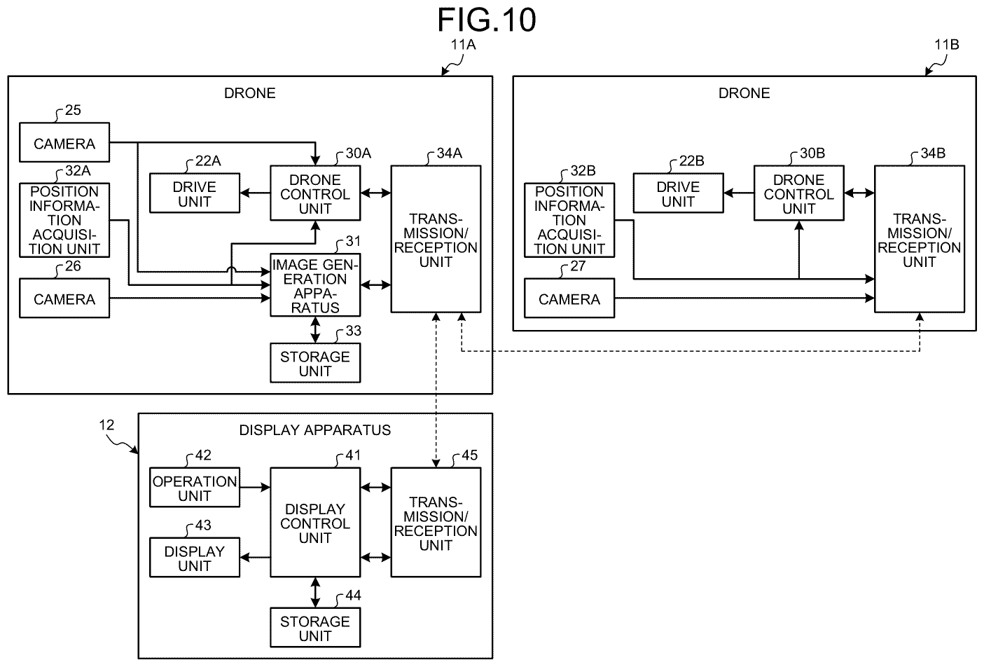

FIG. 10 is a block diagram illustrating an imaging system according to the second embodiment.

As illustrated in FIG. 10, the drone 11A includes a drive unit (mobile body drive unit) 22A, a first camera 25, a second camera 26, a drone control unit (mobile body control unit) 30A, an image generation apparatus 31, a position information acquisition unit (mobile body position information acquisition unit) 32A, a storage unit 33, and a transmission/reception unit 34A.

The drone (mobile body) 11B includes a drive unit (mobile body drive unit) 22B, a second camera 27, a drone control unit (mobile body control unit) 30B, a position information acquisition unit (mobile body position information acquisition unit) 32B, and a transmission/reception unit 34B.

The first camera 25 of the drone 11A photographs (images) the user to acquire the user's position and the user's line of sight as user information. The second camera 26 of the drone 11A is capable of photographing the target T. The second camera 26 captures an image of the target T located in front of the user's line of sight. The second camera 27 of the drone 11B is capable of photographing the target T. The second camera 27 captures an image of the target T located in front of the user's line of sight.

The drone control unit 30A of the drone 11A controls the driving of the drive unit 22A, thereby setting the position, direction, speed, and the like of the drone 11A and controlling the flight of the drone 11A. The drone control unit 30B of the drone 11B controls the driving of the drive unit 22B, thereby setting the position, direction, speed, and the like of the drone 11B and controlling the flight of the drone 11B. The positions of the drones 11A and 11B are preferably set according to the user's position. For example, each of the positions of the drones 11A and 11B is positions at a predetermined distance away from the user where the second cameras 26 and 27 can capture images of the target T located in the user's line of sight. Flight control programs for the drones 11A and 11B used by the drone control units 30A and 30B are set in advance.

The image generation apparatus 31 generates a three-dimensional image based on a plurality of pieces of image data captured by the second cameras 26 and 27, and then generates an image of the target T as viewed by the user using the three-dimensional image. Similarly to the first embodiment, the image generation apparatus 31 includes a data acquisition unit 51, a first image generation unit 52, a second image generation unit 53, and an image interpolation unit 54 (refer to FIG. 4).

The position information acquisition unit 32 A of the drone 11A acquires flight position information of the drone 11A. The position information acquisition unit 32B of the drone 11B acquires the flight position information of the drone 11B.

The storage unit 33 stores image data captured by the second cameras 26 and 27, image data of a three-dimensional image of the target T generated by the image generation apparatus 31, and image data of the target T as viewed by the user.

The transmission/reception units 34A and 34B can transmit and receive various types of data between the transmission/reception units 34A and 34B. The transmission/reception unit 34A can transmit and receive various types of data to and from the display apparatus 12 possessed by the user.

In the above description, the drone 11A and the drone 11B have different configurations, but the drone 11A and the drone 11B may have the same configuration.

The display apparatus 12 includes a display control unit 41, an operation unit 42, a display unit 43, a storage unit 44, and a transmission/reception unit 45. The display apparatus 12 is, for example, a head mount type display apparatus (head mounted display).

### Description of Positional Relationship Between Camera and User

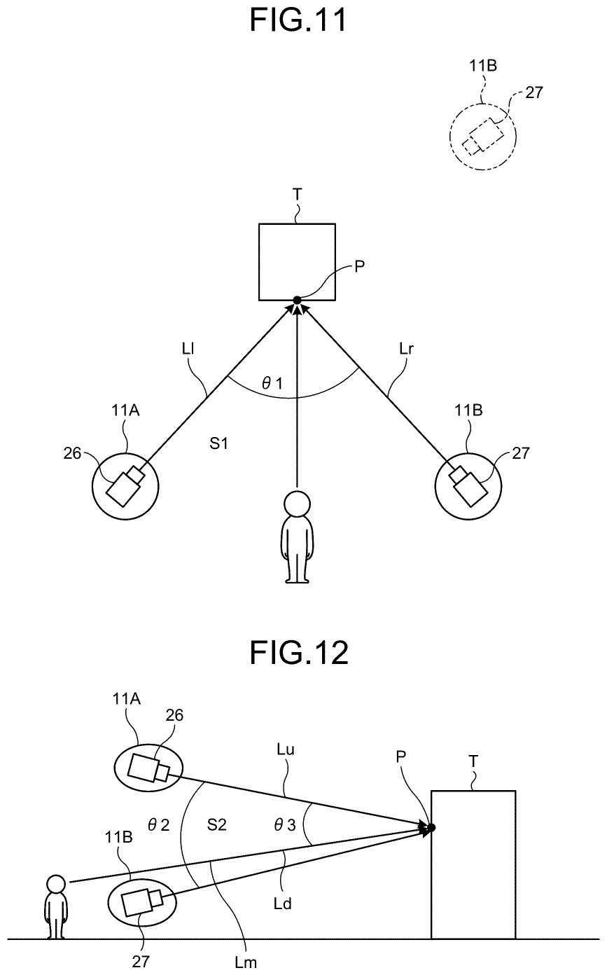

FIG. 11 is a plan view illustrating a positional relationship among the target, the user, and the camera; FIG. 12 is a side view illustrating the positional relationship among the target, the user, and the cameras.

As described above, the first image generation unit 52 generates a three-dimensional image based on the two pieces of image data of the target T acquired by the data acquisition unit 51, and the second image generation unit 53 performs perspective transformation (viewpoint transformation) on the three-dimensional image generated by the first image generation unit 52 to generate a two-dimensional image of the target T as viewed from the position of the user. Accordingly, the second image generation unit 53 uses the image data captured by the two second cameras 26 and 27 as source images to generate the two-dimensional image of the target T as viewed from the position of the user. In this case, the three-dimensional image generated by the first image generation unit 52 is a three-dimensional image of the target T viewed from the drones 11A and 11B side, while the two-dimensional image generated by the second image generation unit 53 is a two-dimensional image of the target T viewed from the user side, which is different in viewpoint. Therefore, when the second image generation unit 53 generates a two-dimensional image from the three-dimensional image, there is a possibility that the image data of the target T is insufficient.

To handle this, when the second image generation unit 53 generates a two-dimensional image from the three-dimensional image, the positions of the two drones 11A and 11B, equipped with the second cameras 26 and 27 (two cameras in total) respectively, are controlled so that there is no insufficiency of image data of the target T. That is, the drone control units 30A and 30B respectively control the moving positions of the drones 11A and 11B based on the position information of the drones 11A and 11B, the user's position information, and the user's line-of-sight information. The drone control units 30A and 30B respectively control the flight positions of the drones 11A and 11B such that the user is positioned in a region S defined by a plurality of connection lines Ll, Lr, Lu, and Ld connecting a vertex P of the target T to the two drones 11A and 11B, i.e., to the cameras 26 and 27. The region S may have a cone shape.

As illustrated in FIG. 11, it is assumed, for example, that the user is positioned in front of the target T in plan view when viewed from above in the vertical direction. In this case, the drones 11A and 11B are preferably located on both sides in the horizontal direction with respect to the user. That is, it is preferable that the user is positioned in a region S1 having the cone shape, defined by the connection line Ll connecting the target T to the drone 11A and the connection line Lr connecting the target T to the drone 11B. In this case, an angle θ1 between the connection lines Ll and Lr with the target T as the vertex P is preferably set to within 90 degrees, but the angle may be at least within 180 degrees. Accordingly, based on the position information of the drones 11A and 11B, the user's position information and the user's line-of-sight information, the drone control units 30A and 30B respectively control the drive units 22A and 22B such that the drones 11A and 11B and the user are positioned in the region S1 having the angle θ1, that is, such that the two drones 11A and 11B form the angle θ1 with respect to the user.

Furthermore, as illustrated in FIG. 12, it is assumed, for example, that the user is positioned in front of the target T in a side view when viewed from one side in the horizontal direction. In this case, the drones 11A and 11B are preferably positioned on the upper side and the lower side in the vertical direction with respect to the user, but may be positioned at least shifted from the user in the vertical direction. That is, it is preferable that the user is positioned in a region S2 having the cone shape, defined by the connection line Lu connecting the target T to the drone 11A and the connection line Ld connecting the target T to the drone 11B. In this case, an angle θ2 between the connection lines Ll and Lr with the target T as the vertex P is preferably set to within 90 degrees, but may be at least within 180 degrees. An angle θ3 between the connection line Lu and a connection line Lm connecting the target T to the user is preferably set to within 90 degrees. Accordingly, based on the position information of the drones 11A and 11B, the user's position information and the user's line-of-sight information, the drone control units 30A and 30B respectively control the drive units 22A and 22B such that the drones 11A and 11B and the user are positioned in the region S2 having the angle θ2, that is, such that the two drones 11A and 11B form the angle θ2 with respect to the user.

In this manner, in the positional relationship between the target T and the user, the drone control units 30A and 30B respectively control the drive units 22A and 22B such that the drones 11A and 11B and the user are positioned in the regions S1 and S2 defined by the connection lines Ll, Lr, Lu and Ld forming the angles θ1 and θ2. Therefore, when the second image generation unit 53 generates a two-dimensional image based on the three-dimensional image generated by the first image generation unit 52, there is substantially no insufficiency of image data of the target T. Accordingly, the image interpolation unit 54 does not need to estimate and interpolate an image of the region for the two-dimensional image of the target T as viewed from the user's position generated by the second image generation unit 53. The image interpolation unit 54 can otherwise reduce the amount of estimating and interpolating the image of the region for the two-dimensional image of the target T as viewed from the user's position generated by the second image generation unit 53. Although the regions S1 and S2 have been described as having the cone shape, the shape is not limited thereto. The two drones 11A and 11B only need to be controlled to be positioned within a region having the angle θ1 between the connection lines Ll and Lr with the target T as the vertex P. Therefore, the regions S1 and S2 may have a polygonal pyramid shape or the like, although they preferably have the cone shape.

When the drone control units 30A and 30B are unable to control the flight positions of the drones 11A and 11B so that the user is located in the regions S1 and S2, the image interpolation unit 54 changes the flight position of the drone 11B as illustrated in FIG. 11 by controlling the driving of the drive unit 22B via the drone control unit 30B, and photographs a missing region with the second camera 27, and adds the image of the missing region from the photographed image.

### Operational Effects of Embodiments

The image generation apparatus of the embodiments includes: the data acquisition unit 51 that acquires image data of the target T from the second cameras (imaging devices) 26, 27, 28, and 29 mounted on the drones (mobile bodies) 11, 11A, 11B; the first image generation unit 52 that generates a three-dimensional image of the target T based on the image data; and the second image generation unit 53 that generates a two-dimensional image of the target T as viewed from a specific viewpoint using the three-dimensional image.

Therefore, the first image generation unit 52 generates a three-dimensional image of the target T based on a plurality of pieces of image data viewed from the drones (mobile bodies) 11, 11A, and 11B, and the second image generation unit 53 generates a two-dimensional image of the target T as viewed from a specific viewpoint using the three-dimensional image. The user can view and save a two-dimensional image of the target T as viewed from a specific viewpoint even if the user does not have a camera.

The image generation apparatus according to at least one embodiment is provided with the second cameras 26 and 27 respectively mounted on the drones 11A and 11B, and further includes: the position information acquisition units (mobile body position information acquisition units) 32A and 32B that respectively acquire position information of the drones 11A and 11B; the first camera (user information acquisition unit) 25 that acquires position information and line-of-sight information of a user who operates the drones 11A and 11B; and the drone control units (mobile body control units) 30A and 30B that respectively control moving positions of the drones 11A and 11B based on the position information of the drones 11A and 11B and the position information and the line-of-sight information of the user. The drone control units 30A and 30B respectively control the moving positions of the drones 11A and 11B such that the user is positioned in the region defined by the plurality of connection lines Ll, Lr, Lu, and Ld connecting the vertex P of the target T to the drones 11A and 11B. This configuration allows the drones 11A and 11B to fly such that the second cameras 26 and 27 are positioned at specific positions with respect to the user. This reduces occlusion when the second image generation unit 53 generates a two-dimensional image using a three-dimensional image, making it possible to generate an appropriate two-dimensional image.

The image generation apparatus according to at least one embodiment further includes the image interpolation unit 54 that estimates and interpolates an image of a region, which has not been acquired by the data acquisition unit 51 at generation of the two-dimensional image of the target T by the second image generation unit 53. This reduces the occlusion at generating a two-dimensional image from a three-dimensional image, making it possible to generate an appropriate two-dimensional image.

The image generation apparatus according to at least one embodiment further includes the image interpolation unit 54 that causes the drones 11, 11A, 11B to move and acquires and interpolates an image of the region, which has not been acquired by the data acquisition unit 51 at generation of the two-dimensional image of the target T by the second image generation unit 53. This reduces the occlusion at generating a two-dimensional image from a three-dimensional image, making it possible to generate an appropriate two-dimensional image.

In at least one embodiment described above, the plurality of imaging devices are mounted on the mobile body, and the three-dimensional image is generated based on the plurality of pieces of image data captured by the imaging devices, but the generation of the image is not limited to this configuration. A single imaging device may be mounted on a mobile body, and a three-dimensional image may be generated based on a plurality of pieces of image data captured from a plurality of different positions to which the single imaging device moves with a time difference.

In the embodiments described above, the image generation apparatus 31 is provided in the drones 11 and 11A, but the image generation apparatus 31 may be provided in the display apparatus 12. That is, the positions of the data acquisition unit 51, the first image generation unit 52, the second image generation unit 53, and the image interpolation unit 54 constituting the image generation apparatus 31 may be on the drone 11 or 11A, the display apparatus 12, or in another location such as the user's home.

Furthermore, in the embodiments described above, the second image generation unit 53 generates the two-dimensional image of the target T from the viewpoint of the user as a specific viewpoint using the three-dimensional image, but may generate the two-dimensional image of the target T as viewed from a desired position designated by the user.

In addition, at least one embodiments described above has described a method of generating three-dimensional image (three-dimensional model) data based on the plurality of pieces of image data captured by the plurality of cameras 26, 27, 28, and 29, the method of generating a three-dimensional image is not limited to this method. For example, a three-dimensional image may be generated by machine learning based on one piece of image data (two-dimensional image) captured by imaging by a single camera, or three-dimensional image (three-dimensional model) data may be generated from one piece of image data using a known method.

While the image generation apparatus according to the present disclosure has been described as above, the image generation apparatus may be implemented in various different forms other than the above-described embodiments.

Each component of the illustrated image generation apparatus is functionally conceptual, and does not necessarily have to be physically configured as illustrated in the drawings. That is, the specific form of each apparatus or device is not limited to the illustrated form, and all or a part thereof may be functionally or physically distributed or integrated in any unit according to a processing load, a use situation, or the like of each apparatus or device.

The configuration of the image generation apparatus is actualized by, for example, a program loaded as software in memory. In the above embodiment, the configurations are described as functional blocks actualized by cooperation of the hardware or software. That is, these functional blocks can be actualized in various forms by only hardware, only software, or a combination of hardware and software.

The image generation apparatus, the image generation method, and the computer-readable storage medium according to the present disclosure can be used, for example, for an imaging system, for example.

According to the present disclosure, it is possible to effectively use image data acquired by an imaging device mounted on a mobile body.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image generation apparatus comprising:
a data acquisition unit configured to acquire image data of a target from a plurality of imaging devices mounted on a mobile body;
a first image generation unit configured to generate a three-dimensional image of the target based on the image data;
a second image generation unit configured to generate a two-dimensional image of the target as viewed from a designated specific viewpoint using the three-dimensional image;
a user information acquisition unit configured to acquire position information and line-of-sight information of a user who operates the mobile bodies; and
a mobile body control unit configured to control a moving position of the mobile body based on position information of the mobile body, and the position information and the line-of-sight information of the user,
wherein the mobile body control unit controls a moving position of the mobile body such that the user is positioned in a region defined by a plurality of connection lines connecting a vertex of the target to the imaging devices.

2. The image generation apparatus according to claim 1,
wherein the imaging devices are mounted on a plurality of the mobile bodies.

3. The image generation apparatus according to claim 1, further comprising an image interpolation unit configured to estimate and interpolate an image of a region, which has not been acquired by the data acquisition unit at generation of the two-dimensional image of the target by the second image generation unit.

4. The image generation apparatus according to claim 1, further comprising an image interpolation unit configured to cause the mobile body to move and configured to acquire and interpolate an image of a region, which has not been acquired by the data acquisition unit at generation of the two-dimensional image of the target by the second image generation unit.

5. The image generation apparatus according to claim 1,
wherein the position information and the line-of-sight information of the user are acquired by imaging the user using at least one of the imaging devices.

6. An image generation method comprising:
acquiring image data of a target from a plurality of imaging devices mounted on a mobile body;
generating a three-dimensional image of the target based on the image data;
generating a two-dimensional image of the target as viewed from a designated specific viewpoint using the three-dimensional image;
acquiring position information and line-of-sight information of a user who operates the mobile body; and
controlling a position of the mobile body based on position information of the mobile body, and the position information and the line-of-sight information of the user,
wherein the controlling includes controlling a moving position of the mobile body such that the user is positioned in a region defined by a plurality of connection lines connecting a vertex of the target to the imaging devices.

7. A non-transitory computer-readable storage medium storing a program causing a computer to perform:
acquiring image data of a target from a plurality of imaging devices mounted on a mobile body;
generating a three-dimensional image of the target based on the image data;
generating a two-dimensional image of the target as viewed from a designated specific viewpoint using the three-dimensional image;
acquiring position information and line-of-sight information of a user who operates the mobile body; and
controlling a position of the mobile body based on position information of the mobile body, and the position information and the line-of-sight information of the user,
wherein the controlling includes controlling a moving position of the mobile body such that the user is positioned in a region defined by a plurality of connection lines connecting a vertex of the target to the imaging devices.
